(19) United States
(12) Patent Application Publication
(10) Pub. No.: US 2013/0085530 A1
(43) Pub. Date: Apr. 4, 2013

(54) TEETHING AND GUM SOOTHING APPARATUS

(71) Applicant: Caroline E. Caputo, Selkirk, NY (US)

(72) Inventor: Caroline E. Caputo, Selkirk, NY (US)

(21) Appl. No.: 13/628,312

(22) Filed: Sep. 27, 2012

Related U.S. Application Data
(60) Provisional application No. 61/541,197, filed on Sep. 30, 2011.

(51) Int. Cl. A61J 17/02

(52) U.S. Cl. CPC A61J 17/02
USPC 606/235

(57) ABSTRACT

The present invention contemplates a variety of apparatuses for a teething and gum soothing device. The teething and gum soothing device relieves gum and mouth soreness for infants, toddlers, elementary school children, orthodontic patients, etc. The teething/gum soothing device is filled with water and partially or completely frozen depending on preference. Some freezing and in-mouth melting allows for a pliable device, which molds to an individual's mouth and may be fitted around orthodontic devices such as braces. Several embodiments of the present invention are envisioned. In some embodiments, the internal mouth apparatus is a “lollipop” apparatus, while in others it is a “mouth chewy”. Also these mouth apparatuses are attached interchangeably with external holders, which in some embodiments are a soft squeezable holder, or a pacifier like holder. The teething/gum soothing device is sized to fit the mouths infants, toddlers, school age children, as well as adults.

### CROSS-REFERENCE TO RELATED APPLICATION

This application is related to and claims the benefit of co-pending application No. 61/541,197, entitled Teething and Gum Soothing Apparatus, filed on Sep. 30, 2011, the entire contents of which are herein incorporated by reference.

### FIELD OF INVENTION

The present invention relates generally to oral devices more specifically to a teething/gum soothing device used to relieve gum or mouth soreness.

### BACKGROUND OF THE INVENTION

Mouth soreness and oral injuries or pain are common, especially among children. Infants often begin teething before their first birthday. “Baby teeth” push through the gums of an infant, causing pain and discomfort and the desire to chew. It is a usual practice to give infants “teething rings” and similar devices to ease their discomfort. Even toddlers may experience pain as their teeth continue to grow and their mouths develop. When children reach early school age (approximately 5 years old), these “baby teeth” begin to fall out and be replaced with an adult set of teeth. Areas in the mouth may become sore from the recent lose of a tooth, as well as from the pressure of an adult tooth forcing its way up and through the surface of the gums. Many children find that their mouths have difficulty accommodating the adult set of teeth, or that the new teeth are coming in incorrectly. Orthodontic procedures, such as braces, are used to correct such difficulties. Unfortunately, braces can be uncomfortable. Wires scrape the inside of the mouth, and the braces reposition the teeth into a forced configuration. It is not unusually for people with braces to complain of mouth aches.

Mouth injuries and sores also affect people of all ages for a variety of reasons. For example, oral surgery, such as a root canal or wisdom teeth extraction, can cause inflammation, pain and soreness in the mouth. The mouth is also a particularly vulnerable spot during athletic activities, prompting some athletes to wear moth guards to protect their teeth. Even so, sports injuries to the mouth can be painful. Simple accidents can also cause mouth pain and soreness, such as biting the tongue or cheek. A cold compress applied against the cheek is sometimes used to alleviate these forms of mouth soreness. Alternatively, pain relief medications, such as acetaminophen or aspirin, are used to alleviate mouth soreness.

### SUMMARY OF THE INVENTION

The present invention contemplates a variety of apparatuses for a teething and gum soothing device. The teething and gum soothing device relieves gum and mouth soreness for infants, toddlers, elementary school children, orthodontic patients, etc. The teething/gum soothing device is filled with water and partially or completely frozen depending on preference. Some freezing and in-mouth melting allows for a pliable device, which molds to an individual's mouth and may be fitted around orthodontic devices such as braces. Several embodiments of the present invention are envisioned. In some embodiments, the internal mouth apparatus is a “lollipop” apparatus, while in others it is a “mouth chewy”. Also these mouth apparatuses are attached interchangeably with external holders, which in some embodiments are a soft squeezable holder, or a pacifier like holder. The teething/gum soothing device is sized to fit the mouths infants, toddlers, school age children, as well as adults.

A first aspect of the present invention provides a gum soothing device, comprising a hollow mouth apparatus capable of receiving water, a handle positioned on a front portion of the mouth apparatus, and a cap capable of preventing water in the hollow mouth apparatus from escaping.

A second aspect of the present invention provides a teething apparatus, comprising a hollow mouth piece to receive water, a pacifier shaped handle, and a cap.

A third aspect of the present invention provides a method of treating mouth soreness, comprising filling a hollow mouth apparatus with water, sealing the hollow mouth apparatus, cooling the hollow mouth apparatus, and inserting the hollow mouth apparatus into a mouth.

### BRIEF DESCRIPTION OF DRAWINGS

These and other objects, features, and characteristics of the present invention will become more apparent to those skilled in the art from a study of the following detailed description in conjunction with the appended claims and drawings, all of which form a part of this specification. In the drawings:

FIG. 1 illustrates a one piece unit gum soothing device according to an embodiment of the present invention.

FIG. 2 illustrates an upper and lower piece unit gum soothing device according to an embodiment of the present invention.

FIG. 3 illustrates gum soothing device handles according to embodiments of the present invention.

FIG. 4 depicts a method flow diagram according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. When used, like numbering represents like elements.

### DETAILED DESCRIPTION OF THE INVENTION

The present invention offers devices and methods that addresses the problem of mouth soreness in young children, such as infants and toddlers, as well as anyone in need of relief from gum or mouth soreness. Whereas traditional methods of tackling mouth soreness, pain, or aches, include cold compresses, medication, and teething rings for small children, the present invention offers a better solution. In one embodiment the present invention offers a cool apparatus inserted in the mouth that can be chewed upon and can conform to the individual shape of a user's mouth. Several embodiments of the present invention, allowing for age and preferences of the user, are discussed below.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

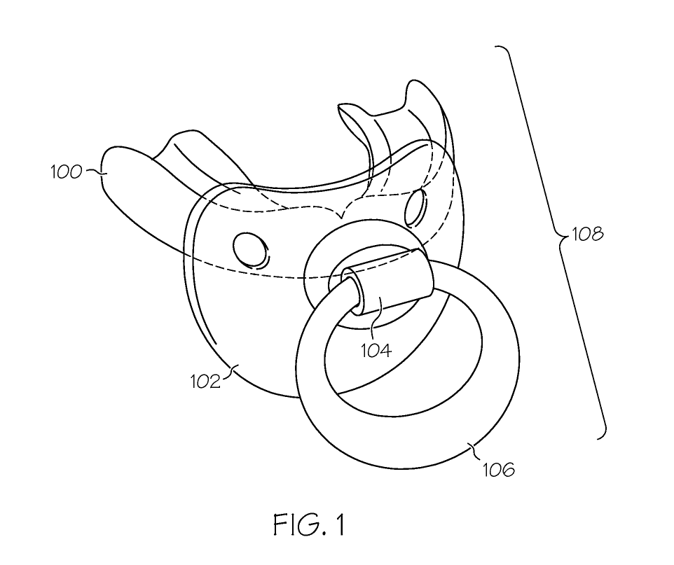

Referring now to FIG. 1, one piece unit gum soothing device 108 according to an embodiment of the present invention is illustrated. In the present embodiment, soothing device 108 comprises one piece mouth apparatus 100 and pacifier-like handle 102. Pacifier-like handle 102 further comprises cap 104 and optional ring 106. In preferred embodiments, mouth apparatus 100 is made of non-toxic, hygienically formed, natural bite-resilient materials such as: BPA (Bisphenol A) free plastic, orthodontic latex, or 100% medical grade silicone. This is not intended as an all inclusive list of materials from which mouth apparatus 100 can be made, and additional materials will be apparent to those trained in the art. All of soothing device 108 may be comprised of such non-toxic, hygienically formed, natural bite-resilient materials, although in some embodiments components of soothing device 108 external to the mouth, such as ring 106 can be formed of other materials.

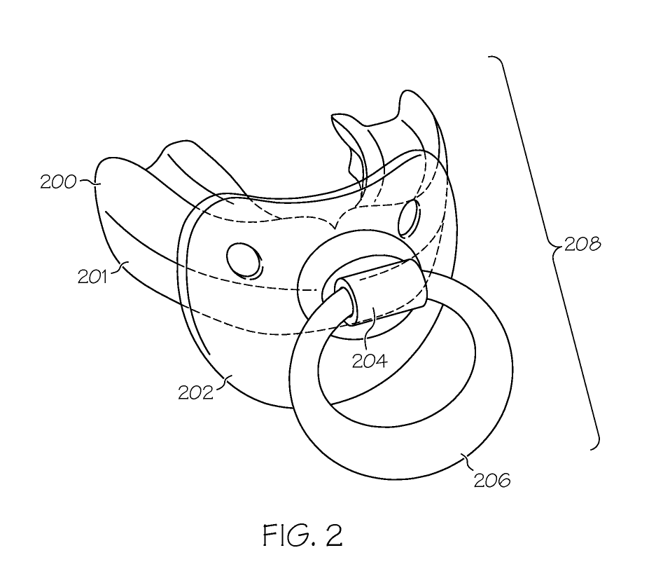

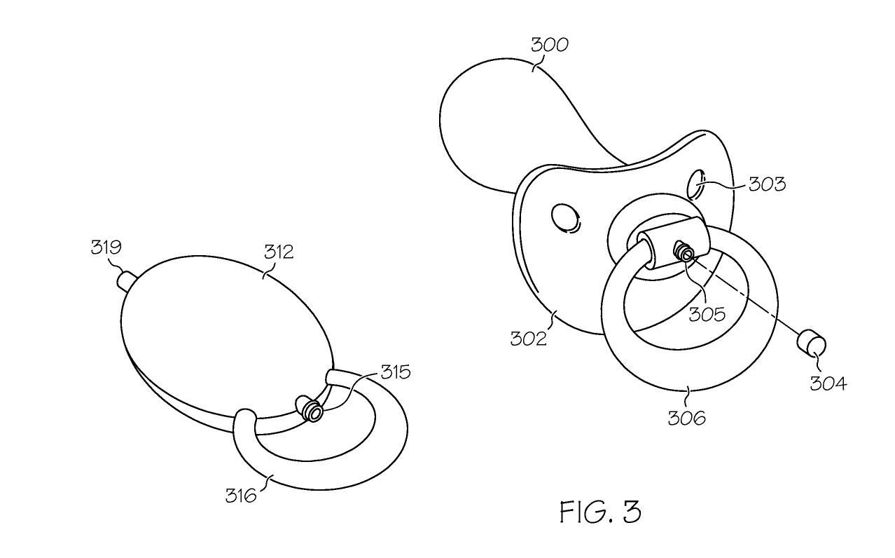

Several mouth apparatus embodiments are envisioned. Mouth apparatus 100 (FIG. 1) depicts a one piece unit “mouth chewy.” An upper and lower piece unit “mouth chewy” will be discussed further below with reference to FIG. 2. Another embodiment of the mouth apparatus is a “lollipop” apparatus, which will be discussed briefly here and in further detail below with reference to FIG. 3. A “mouth chewy”, as shown by Mouth apparatus 100 in FIG. 1, has the general shape of the perimeter of the human mouth, or a U-shape. The “mouth chewy” lies between the upper and lower sets of teeth (or gums in the case of infants) and when compressed by these teeth or gums conforms around said teeth/gums. If a person has braces, or other orthodontic appliances, the “mouth chewy” also conforms around such appliances. A “lollipop” apparatus (see FIG. 3 and paragraph 19) is a comparatively looser apparatus which a user can move about his/her mouth. The “lollipop” apparatus can be moved with the tongue to a sore section of the mouth, chewed by the teeth, or sucked like a lollipop, whichever offers the user relief from mouth soreness or pain. The “lollipop” apparatus can also conform around sections of the mouth (e.g. both sides of a sore tooth) to offer relief.

Mouth apparatus 100 is essentially a hollow compartment, preferably with a single opening for receiving liquid and at which handle 102 attaches. Preferably, mouth apparatus 100 is filled with water, although any safe, non-toxic liquid can be used to fill mouth apparatus 100. An opening is located at the front of mouth apparatus 100 (i.e. the bottom of mouth apparatus 100's U-shape). In a “lollipop” apparatus, this opening is located on an end of the “lollipop.” Handle 102 attaches at this opening, and in preferred embodiments, liquid is poured into mouth apparatus 100 through a passage in handle 102 leading to mouth apparatus 100 on one end and sealable by cap 104 on the other.

Several handle embodiments are envisioned. In brief they are: a pacifier-like handle (e.g., pacifier-like handles 102 in FIGS. 1 and 302 in FIG. 3) and a soft squeezable handle (e.g., soft squeezable handle 312 in FIG. 3). These embodiments will be discussed in further detail below with reference to FIG. 3. Different handle embodiments may be interchangeably attached to a mouth apparatus and vice-versa. For example, a pacifier-like handle on a “mouth chewy” mouth apparatus can be removed and replaced with a soft squeezable handle. Likewise, a “mouth chewy” mouth apparatus can be removed from a pacifier-like handle and replaced with a “lollipop” mouth apparatus. A handle and a mouth appliance may attach by several methods, including, but not limited to, screwing together, snapping together, popping together, pushing/pulling, and twisting together. The attachment should be water-tight. As discussed hereinabove, handle 102 has cap 104, which seals soothing device 108, preventing liquid from escaping soothing device 108 when cap 104 is in a closed position. Cap 104 attaches to handle 102 by a variety of methods, including, but not limited to, screwing, snapping, popping, pushing/pulling, and twisting together. While in FIG. 1 cap 104 is show attaching to the “nose” of handle 102, cap 104 can attach to any part of soothing device 108, and is not limited to attaching to handle 102. Additionally, in some embodiments, handle 102 has finger ring 106. Ring 106 offers, among other benefits which will be apparent to those trained in the art, an additional surface with which to grip soothing device 108. Finger ring 106 is preferably made from resilient flexible plastic, which may also be grooved or have a partially raised surface for an enhanced grip.

Referring now to FIG. 2 upper and lower piece unit gum soothing device 208 according to an embodiment of the present invention is illustrated. In this embodiment, soothing device 208 comprises: upper piece mouth apparatus 200, lower piece mouth apparatus 201, and pacifier-like handle 202. Pacifier-like handle 202 further comprises cap 204 and optional ring 206. Pacifier-like handle 202 is the same type of handle as pacifier-like handle 102 (FIG. 1). Soothing device 208 differs from soothing device 108 (FIG. 1) with respect to these devices mouth apparatuses. Whereas both apparatuses are examples of the “mouth chewy,” mouth apparatus 100 of soothing device 108 (FIG. 1) has only a single layer of “mouth chewy,” while mouth apparatuses 200 and 201 of soothing device 208 (FIG. 2) form a double layer “mouth chewy.” Both forms of “mouth chewy” mouth apparatus can conform around structures in the mouth to form a personalized fit. Mouth apparatus 100 (FIG. 1) is squeezed between a set of teeth or gums and shared between the set to become a conforming intermediate layer. Alternatively, upper piece mouth apparatus 200 (FIG. 2) can conform solely around a top layer of teeth/gums, with lower piece mouth apparatus 201 (FIG. 2) conforming solely around a lower layer of teeth/gums. Mouth apparatuses 200 and 201 can be two separate compartments, a set of semi-attached compartments, or compartments that are essentially connected.

Referring now to FIG. 3 gum soothing device handles 302 and 312 according to embodiments of the present invention are illustrated. Pacifier-like handle 302 is shown on the right with cap 304. Pacifier-like handles have been discussed above in some detail with reference to pacifier-like handles 102 (FIG. 1) and 202 (FIG. 2), and will be further discussed here. The features previously attributed to pacifier-like handles 102 (FIG. 1) and 202 (FIG. 2) are also true to pacifier-like handle 302, as well as to all pacifier-like handles. It should be noted that a handle is also called a holder, and the two terms may be used interchangeably in this discussion. Pacifier-like handle 302 has air holes 303, which encourage natural breathing through pacifier-like handle 302 and into a wearer's mouth. Pacifier-like handle 302 is also shown with finger 306 attached at the front of the pacifier for enhanced gripping. Cap 304 and cap attachment port 305 are shown on the nose of pacifier-like handle 302, although cap 304 and cap attachment port 305 could be located on any part of pacifier-like handle 302 or a mouth assembly attached to it.

Soft squeezable handle 312 can be used outside the mouth in the same manner as pacifier-like handle 302. Soft squeezable handle 312 is preferably pliable, made of materials such as rubber or soft plastic. In a preferred embodiment, soft squeezable handle 312 is sufficiently thick and wide that a liquid, preferably water, may pass through it and into a mouth apparatus. Liquid enters soft squeezable handle 312 at opening 315, and passes through soft squeezable handle 312 to connector 319 which connects to a mouth apparatus. Opening 315 can be sealed by cap 304. This sealing can be in various forms, including, but not limited to cap 304 screwing, snapping, popping, pushing/pulling, and twisting onto opening 315. Additionally, soft squeezable handle 312 may have optional finger ring 316 which adds a gripping surface to the handle. Finger ring 316 is preferably made from resilient flexible plastic, which may also be grooved or have a partially raised surface for an enhanced grip. Although not typical, ventilation holes can be added to soft squeezable handle 312 to promote normal breathing and prevent soft squeezable handle 312 from obstructing such breathing patterns.

Still referring to FIG. 3, “lollipop” mouth apparatus 300 according to an embodiment of the present invention is shown. Whereas the “mouth chewy” described above is intended to remain relatively stationary in the mouth, “lollipop” mouth apparatus 300 can be moved about the mouth and is like a soothing, semi-soft, ice cube. A user will find relief from manipulating “lollipop” mouth apparatus 300 about the mouth in much the same manner as a lollipop, “sucker,” or hard-candy. The mouth apparatus sooths sore areas. Sucking and chewing are soothing, therapeutic acts. “Lollipop” mouth apparatus 300 is tethered outside the mouth by a handle (such as pacifier-like handle 302), which prevents accidental swallowing.

In order to use the soothing device of the present invention, one should first ensure that the mouth apparatus and handle of the device are securely together, interlocked in a water-tight fashion. The soothing device is then filled with liquid, preferably water, but not limited to such. The device is then capped such that no liquid can escape and placed in a refrigerator or freezer. It may be desirable to cool, partially freeze, or totally freeze the device, depending on personal preference. The goal is to produce a gel-like, semi-pliable, cold soothing device that will be comfortable to the individual user. If the soothing device is too frozen, it can be allowed to thaw until the desired ice-water consistency is found. In a preferred embodiment the mouth apparatus is made from a semi-transparent material that allows observation of the ice inside the mouth apparatus. Once the mouth apparatus is at the desired ice-water consistency, the mouth apparatus is inserted into a mouth, leaving the handle exposed outside the mouth. The mouth apparatus conforms around structures inside the mouth such as teeth and gums to create a unique personalized fit.

As the soothing device is used in the mouth, it is desirable to sanitize this device. Several methods are available including, but not limited to, inserting the device in a pot of boiling water, rinsing the device in a dishwashing machine, and cooking the device in a microwave oven. Preferably, the soothing device should be made of materials capable of withstanding such environments. Generally, the soothing device should be able to withstand at least one of these methods, or an alternative sterilization method.

The teething and gum soothing device/apparatus encourages healthy oral development and supports natural healing alternatives to medication. The ability of the soothing device to mold closely to teeth, gums and braces allows for on-site treatment of soreness and aches. The cool temperature of the device can be used to prevent inflammation in the event of injury (e.g. a sports injury), which reduces healing time. Furthermore, the “mouth chewy” and “lollipop” mouth apparatuses allow free movement and exercise of the tongue, palate, and jaw. The mouth apparatus can also be used to reduce pressures on the jaw and allow the jaw to relax, which can reduce tension and soreness.

In addition to the embodiments discussed hereinabove, teething/gum soothing device/apparatus has several general variations. The soothing device can be made in a variety of sizes for people of different age groups. As people age, their mouths grow larger. Example age groups include, but are not limited to: infant (˜0-1 yrs.), toddler (˜1-3 yrs), child (˜3-10 yrs), adolescent (˜10-18 yrs), and adult (>18 yrs). While a variety of materials may be utilized in the soothing device, materials with certain properties are preferred. For example, the mouth apparatus is preferably made with semi- to very transparent material so as to allow one to see the ice and water mixture in order to determine desirability. Also, it is desirable for the device itself to be small and light enough to prevent triggering a gag reflex and/or falling out of a wearer's mouth under the force of its own weight. However, the soothing device should be sufficiently strong and durable to prevent the device from being punctured by teeth or otherwise damaged, and thick enough to be chewed upon. The material itself should be soothing in the mouth, and comfortable against sores and aches. While these qualities are preferred in materials for the soothing device, they are not necessary for the device to function and should not be viewed as limiting.

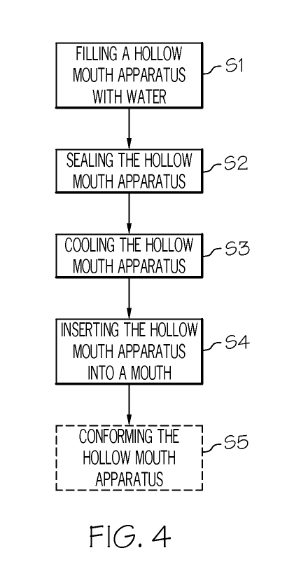

Referring now to FIG. 4, a method flow diagram for a method of treating mouth soreness according to an embodiment of the present invention is shown. In step S1, a hollow mouth apparatus is filled with water. In step S2, the hollow mouth apparatus is sealed. In step S3, the hollow mouth apparatus is cooled. In step S4, the hollow mouth apparatus is inserted into a mouth. In an optional step S5, the hollow mouth apparatus is conformed, usually around one of gums, teeth, or an orthodontic appliance.

In addition to the above mentioned examples, various other modifications and alterations of the present invention may be made without departing from the present invention. While the invention has been particularly shown and described in conjunction with preferred embodiments thereof, it will be appreciated that variations and modifications will occur to those skilled in the art. Accordingly, the above disclosure is not to be considered as limiting, and the appended claims are to be interpreted as encompassing the true spirit and the entire scope of the invention.

What is claimed is:

1. A gum soothing device, comprising:
a hollow mouth apparatus capable of receiving water;
a handle positioned on a front portion of the mouth apparatus; and
a cap capable of preventing water in the hollow mouth apparatus from escaping.

2. The gum soothing device of claim 1, the mouth apparatus being moldable around at least one of: teeth, gums, and orthodontic appliances.

3. The gum soothing device of claim 1, the mouth apparatus being at least one one of: a lollipop or a mouth chewy.

4. The gum soothing device of claim 1, the mouth apparatus being comprised of at least one of: BPA free plastic, orthodontic latex, and medical grade silicone.

5. The gum soothing device of claim 1, the mouth apparatus comprising at least one of: a one piece unit and an upper and lower piece unit.

6. The gum soothing device of claim 1, the mouth apparatus being sized to fit the mouth of at least one of: an infant, a toddler, a child, an adolescent, and an adult.

7. The gum soothing device of claim 1, the mouth apparatus being filled with water and at least one of: frozen and partially frozen.

8. The gum soothing device of claim 1, the handle being at least one of: a soft pliable holder, and a pacifier like holder.

9. The gum soothing device of claim 8, the soft, pliable holder and the pacifier like holder handles being interchangeable with a single mouth apparatus.

10. The gum soothing device of claim 1, the holder having ventilation holes.

11. The gum soothing device of claim 1, the device being capable of withstanding at least one of: a dishwasher machine; a microwave oven, and boiling water.

12. The gum soothing device of claim 1, the device being sufficiently light weight so as to not fall out of a mouth and sufficiently thick to be chewed without being punctured by teeth.

13. A teething apparatus, comprising:
a hollow mouth piece to receive water;
a pacifier shaped handle; and
a cap.

14. The teething apparatus of claim 13, the hollow mouth piece being a mouth chewy comprising at least a one piece unit.

15. The teething apparatus of claim 13, the mouth piece conforming to the mouth of the wearer.

16. A method of treating mouth soreness, comprising:
filling a hollow mouth apparatus with water;
sealing the hollow mouth apparatus;
cooling the hollow mouth apparatus; and
inserting the hollow mouth apparatus into a mouth.

17. The method of claim 16, the method further comprising:
maintaining a handle to the mouth apparatus outside the mouth.

18. The method of claim 16, the cooling the hollow mouth apparatus comprising at least one of: chilling the apparatus in a refrigerator, partly freezing the apparatus, and completely freezing the apparatus.

19. The method of claim 16, the method further comprising:
conforming the hollow mouth apparatus around at least one of: gums, teeth, or an orthodontic appliance.

20. The method of claim 16, the method further comprising:
chewing on the hollow mouth apparatus.
